(19) United States
(12) Patent Application Publication
(10) Pub. No.: US 2011/0144840 A1
(43) Pub. Date: Jun. 16, 2011

(54) Expandable Energy Storage Control System and Method

(75) Inventors: Changqing Ye, Carlsbad, CA (US); Michael D. Wilk, Temecula, CA (US)

(73) Assignee: ISE CORPORATION, Poway, CA (US)

(21) Appl. No.: 12/638,209

(22) Filed: Dec. 15, 2009

(51) Int. Cl. B60L 15/20; B60L 11/18

(52) U.S. Cl. 701/22; 180/65.29; 903/903

(57) ABSTRACT

An expandable energy storage system for a hybrid electric vehicle has one or more energy storage modules each including a plurality of energy storage cells and a module controller, and a system controller which communicates with the module controller or controllers of the one or more energy storage modules via a controller communication bus and which is powered by the vehicle's low voltage power supply. Each module controller communicates with the energy storage cells in the associated module via an energy storage cell communication link, and is powered by the energy storage cells in the associated module. The system controller communicates with the hybrid electric vehicle via the vehicle communication bus. The modular design provides an energy storage system which can be expanded by connecting additional energy storage modules to the system.

### BACKGROUND

1. Field of the Invention

The present invention relates generally to hybrid electric vehicles and is particularly concerned with a propulsion energy storage and control system and method for a hybrid electric vehicle.

2. Related Art

A hybrid electric vehicle (or “HEV”) is a vehicle which combines a conventional propulsion system with an on-board rechargeable propulsion energy storage system to achieve better fuel economy and cleaner emissions than a conventional vehicle. While HEVs are commonly associated with automobiles, heavy-duty hybrids also exist. In the U.S., a heavy-duty vehicle is legally defined as having a gross weight of over 8,500 lbs. A heavy-duty HEV will typically have a gross weight of over 10,000 lbs. and may include vehicles such as a metropolitan transit bus, a refuse collection truck, a semi tractor-trailer, or the like.

The efficiency and emissions of a HEV depend on the particular configuration of the subsystems making up the hybrid power system and the control system which integrates the subsystems. Existing HEVs often have complex integration systems which increase the cost of such vehicles.

HEV configurations fall into two basic categories: series and parallel. In a parallel configuration, either an internal combustion engine or an electric motor can apply torque to turn the wheels. Electrical energy is stored in an energy storage device, such as a battery pack or an ultracapacitor pack, and may be used to assist the drive wheels as needed, for example during acceleration. In a series configuration, the internal combustion engine (ICE) drives a generator which can charge the propulsion energy storage and/or power the electric drive motor. In a series configuration there is no mechanical coupling of the engine drive shaft and the drive wheels. An advantage of series HEVs is that the ICE can be located anywhere in the vehicle because it does not transmit power mechanically to the wheels. In contrast, parallel configurations must connect both the motor and the ICE engine to the drive train, generally requiring the motor and engine to be aligned and close to one another.

Energy storage packs in hybrid vehicles, particularly heavy duty vehicles, reside in a harsh operating environment and face unique challenges not present in non-vehicular applications. In particular, the environment is hot, dirty, and subject to vibration. As such, individual cells within an energy storage pack may be more susceptible, among other things, to vary from cell to cell compared to stationary applications. For example, different cells may charge at different rates and individual cells may deteriorate at a faster rate than other cells within a pack. In addition, due to the very high voltages in which some heavy duty hybrid vehicles operate, there are unique challenges in controlling the energy storage packs in such vehicles. Current multi-cell energy storage implementations include integrated cell balancing, voltage monitoring, and temperature monitoring, but leave room for improvement. Another problem with existing energy storage packs and associated control systems is that additional energy storage modules cannot readily be added to an existing system if more power is needed. Instead, a completely new system must be designed for each vehicle having different energy storage requirements.

### SUMMARY

Embodiments described herein provide an energy storage system and method for a hybrid electric vehicle having a series or parallel hybrid drive configuration. According to one aspect, a propulsion energy storage system specially adapted for a hybrid electric vehicle comprises at least a first energy storage module, a system controller configured to communicate with the hybrid electric vehicle via a vehicle communication bus, and a controller communication bus communicatively coupled with the system controller and with the first module controller for communications between the first module controller and system controller. The energy storage module may then have a first plurality of energy storage cells, a first energy storage cell communication link, and a first module controller configured to communicate with the first plurality of energy storage cells via the first energy storage cell communication link. In one embodiment, a low voltage power supply of the vehicle provides power for the system controller and the first module controller is powered by the first plurality of energy storage cells. While it may seem counterintuitive and unnecessarily complex, the inventors have found that a serial communication protocol stack and supporting system architecture as described below, actually provides multiple advantages in controlling a propulsion energy storage in a heavy duty hybrid electric vehicle.

In one embodiment, the system comprises a plurality of energy storage modules, each energy storage module having a respective module controller communicating with the system controller via the controller communication link and with the energy storage cells of the associated energy storage module via a respective energy storage cell communication link. Each module controller is powered by the energy storage cells of the respective energy storage module with which it is associated, and may comprise a processor coupled with individual energy storage cells and with various sensors in the energy storage module proximate the cells.

An electrical isolator may be located between each module controller and the controller communication bus to electrically isolate communications between the module controllers and controller communication bus.

In one embodiment, the system controller communicates over the vehicle communication bus using a first protocol and over the controller communication bus using a second protocol which is simpler than the first protocol. The module controller communicates over the controller communication bus using the second protocol and over the energy storage cell communication link using a third protocol which is simpler than the second protocol. In one embodiment, the first protocol is a controller area network (CAN), the second protocol is a local interconnect network (LIN), and the third protocol is a serial peripheral interface (SPI).

In this system, the main or overall system controller communicates with the vehicle and with the one or more module controllers and may also be programmed to carry out various system diagnostics such as determining the state of charge and state of health of the energy storage modules. Each module controller may be configured to measure the voltage between cells, and to balance the cells during charging and discharging. The module controllers may also be configured to measure module current and ground isolation.

According to another aspect, a method of controlling propulsion energy storage of a hybrid electric vehicle comprises providing power to a system controller from a low voltage power supply of the hybrid electric vehicle, providing power to at least a first energy storage module controller of a first energy storage module from a first plurality of energy storage cells associated with the first energy storage module, communicating in a first protocol between the system controller and the hybrid electric vehicle via a vehicle communication bus, and communicating in a second protocol between at least the first energy storage module controller and the system controller via a controller communication bus. In one embodiment, the method further comprises communicating in a third protocol between the first energy storage module controller and the first plurality of energy storage cells via a first energy storage cell communication link.

Due to the high voltages and complex communications between a power supply and a hybrid electric vehicle, an isolated, complex communication protocol is needed. By providing separate system controllers and energy storage module controllers, communications can be separated into different communication levels or tiers for control communications within individual energy storage modules, control communications between the energy storage modules and an overall system controller, and the higher level communications required between the system controller and the hybrid electric vehicle network. Thus, simpler communication protocols can be used for the lower level communications. In one embodiment, a high level communication network or broadcast serial network such as CAN is used as the first protocol over the vehicle communication bus. A lower level protocol such as LIN is used as the second protocol for communications between the system controller and storage module controllers, and an even simpler protocol such as SPI is used for communications within individual energy storage modules.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a schematic block diagram illustrating a hybrid electric vehicle propulsion system in a series configuration;

FIG. 2 is a schematic diagram illustrating one embodiment of a modular propulsion energy storage system of a hybrid electric vehicle which includes a built-in energy storage control system;

FIG. 3A is block diagram of one of the electrical isolators of FIGS. 2 and 4;

FIG. 3B is a more detailed schematic diagram of one embodiment of an electrical circuit for the isolator of FIG. 3A;

FIG. 4 is a block diagram of the system of FIG. 2 illustrating additional details;

FIG. 5 illustrates one generic embodiment of a cell balancing circuit;

FIG. 6 is a flow chart of an exemplary method for providing communication between the controllers in the propulsion energy storage system of FIGS. 2 and 4;

FIG. 7 is a flow diagram illustrating one embodiment of a method of controlling the energy storage system of FIGS. 2 and 4.

### DETAILED DESCRIPTION

After reading this description it will become apparent to one skilled in the art how to implement the invention in various alternative embodiments and alternative applications. However, although various embodiments of the present invention are described herein, it is understood that these embodiments are presented by way of example only, and not limitation. As such, this detailed description of various alternative embodiments should not be construed to limit the scope or breadth of the present invention as set forth in the appended claims.

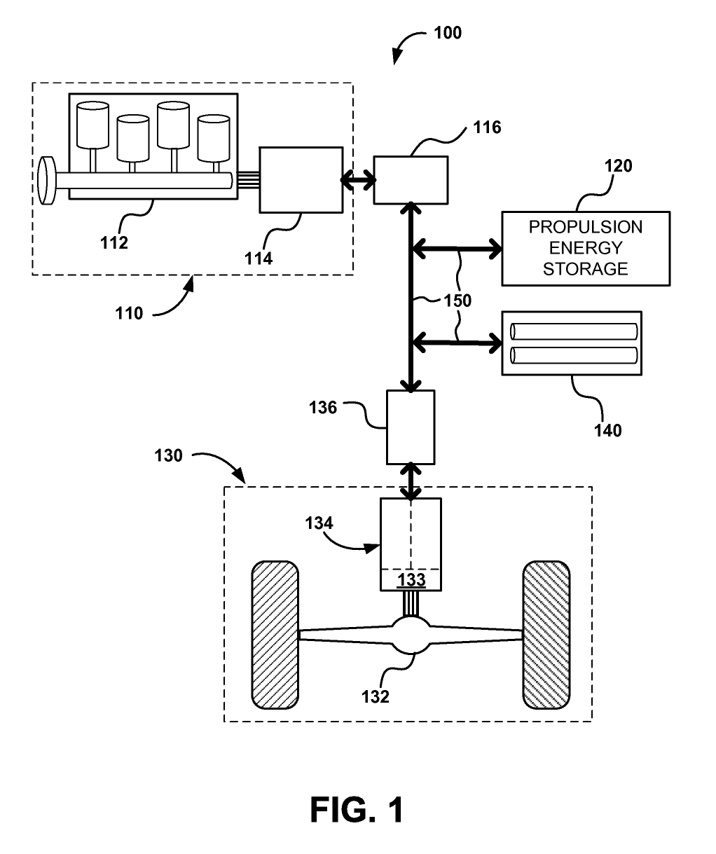

FIG. 1 illustrates a hybrid electric vehicle (HEV) high voltage propulsion system 100 including a propulsion energy storage 120. The drive system 100 may be used in a heavy-duty vehicle having a gross vehicle weight (GVW) of at least 10,000 lbs, such as a bus, a heavy duty truck, a semi tractor-trailer, a refuse collection vehicle, a tractor or other farm vehicle, a tram, or the like.

The components illustrated in FIG. 1 are conventional HEV propulsion system components. System 100 includes an energy generation source such as an “engine genset” 110 comprising an engine 112 coupled to a generator 114 and one or more electrical propulsion motors 134 mechanically coupled to a drive wheel assembly 132 via gearbox 133. As illustrated, the engine 112 of engine genset 110 may be a conventional gasoline or diesel internal combustion engine (ICE), or other types of vehicle drive engines such as a hydrogen fueled ICE (H-ICE), a compressed natural gas engine (CNG), a liquefied natural gas engine (LNG) or the like. In the alternate, engine genset 110 may be replaced by a fuel cell (not shown). The engine 112 (here illustrated as an ICE) drives generator 114, which generates electricity to power one or more electric propulsion motor(s) 134 and/or charge the energy storage cells of the energy storage via DC high power bus 150 (propulsion and charging power bus). In this way, energy can be transferred between components of the high power hybrid drive system as needed. As illustrated, HEV drive system 100 includes a first inverter 116 between the generator 114 and the DC high power bus 150, and a second inverter 136 between the electric propulsion motor 134 and the DC high power bus 150. Here the inverters 116, 136 are shown as separate devices, however it is understood that their functionality can be incorporated into a single unit. It is further understood that inverters 116 and 136 may function as rectifiers, or otherwise condition propulsion energy as appropriate.

Unique to a HEV, the vehicle will typically have both a high voltage electrical system and a low voltage electrical system. Hybrid drive system 100 provides the vehicle's high voltage system, which is partially illustrated in FIG. 1 by heavy lines, representing a high power supply for vehicle propulsion and other high power demands. Moreover, a HEV may include both AC and DC high power systems. For example, the drive system 100 may generate, and run on, high power AC, but it may also convert it to DC for storage and/or transfer between components across the DC high power bus 150. Current may be converted back and forth between AC and DC via the inverter/rectifier 116, 136 or other suitable device (hereinafter “inverters” or “AC-DC converters”). Inverters 116, 136 for heavy-duty vehicles (i.e., having a gross weight of over 10,000) are costly, specialized components, which may include, for example, a special high frequency (e.g., 2-10 kHz) IGBT multiple phase water-glycol cooled inverter with a rated DC voltage of 650 VDC and having a peak current of 300 A.

In addition to the high voltage power supply, the HEV also has a low voltage or auxiliary power supply which is used as the power supply of the starter that starts ICE engine 112, various low power vehicle devices such as a radio and lights, and various system controllers. The low voltage system is defined herein and being below 50 VDC, but will typically comprise a 12 VDC, 24 VDC, or 48 VDC power supply. The low voltage system is akin to the electrical system of a conventional (non-hybrid) vehicle.

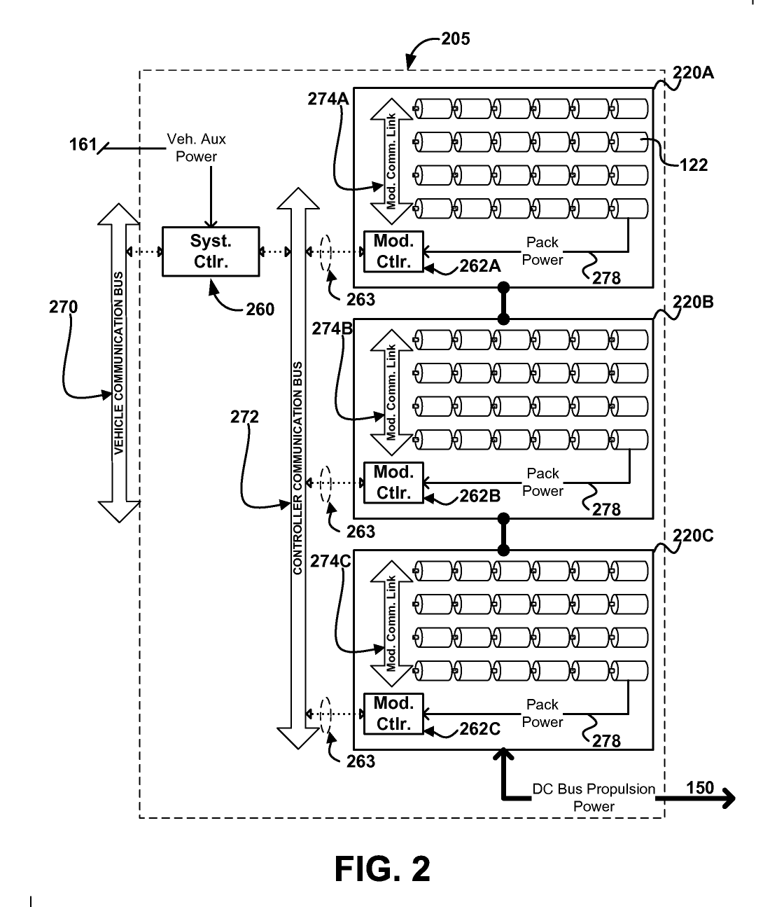

Power from the propulsion energy storage 120 may solely power the one or more electric propulsion motor(s) 134 or may augment power provided by the engine genset 110. To appreciate the power level involved, heavy-duty HEVs may operate off a high voltage electrical power system rated at, for example, over 500 VDC. Similarly, propulsion motor(s) 134 for heavy-duty vehicles (here, having a gross weight of over 10,000) may include, for example, two AC induction motors that produce 85 kW of power (×2) and having a rated DC voltage of 650 VDC. The propulsion energy storage system may include one or more energy storage modules, as described in more detail below and in connection with FIGS. 2 to 4.

Unlike lower-rated electrical systems, heavy-duty high power HEV drive system components may also generate substantial amounts of heat. Due to the high temperatures generated, high power electronic components such as the generator 114 and electric propulsion motor(s) 134, for example, are typically cooled (e.g., water-glycol cooled), and may also be included in the same cooling loop as the ICE 112.

As a key added feature of HEV efficiency, many HEVs recapture the kinetic energy of the vehicle via regenerative braking rather than dissipating kinetic energy via friction braking. In particular, regenerative braking (“regen”) is where the electric propulsion motor(s) 134 are switched to operate as generators, and a reverse torque is applied to the drive wheel assembly 132. In this process, the vehicle is slowed down by the main drive motor(s) 134, which converts the vehicle's kinetic energy to electrical energy. As the vehicle transfers its kinetic energy to the motor(s) 134, now operating as a generator(s), the vehicle slows and electricity is generated and stored by the energy storage 120. When the vehicle needs this stored energy for acceleration or other power needs, it is released from energy storage 120. This is particularly valuable for vehicles whose drive cycles include a significant amount of stopping and accelerating (e.g., metropolitan transit buses). Regenerative braking may also be incorporated into an all-electric vehicle (EV) thereby providing an onboard source of electricity generation (recapture).

When the propulsion energy storage 120 reaches a predetermined capacity (e.g., fully charged), the drive wheel propulsion assembly 130 may continue to operate in regen for efficient braking However, instead of storing the energy generated, any additional regenerated electricity may be dissipated through a resistive braking resistor 140. Typically, the braking resistor 140 is included in the cooling loop of the ICE 112, and dissipates the excess energy as heat.

Certain embodiments as disclosed herein provide for a propulsion energy storage system specially adapted for a hybrid electric vehicle, which includes a control system having multiple tiers of communication using different protocols, and which allows for addition and removal of energy storage modules without changing the system controller. In particular, the energy storage control system and method of the embodiments that follow form a tiered system such that monitoring and control functions for the energy storage system can be separated from the vehicle-level monitoring and control functions. The tiered communication architecture described herein may include direct and bus communications. The control and monitoring functions are tiered within the energy storage system between a system controller, powered by vehicle auxiliary power, and one or more individual energy storage module controllers, powered by the energy storage cells in their respective modules.

The system controller and module controllers are coordinated to control operation of the energy storage cells according to system requirements. In one embodiment, the system controller communicates with the vehicle via a first communication bus, and communicates with the module controller or controllers via a second communication bus. Additionally, the module controllers communicate with energy storage cells within the respective modules via a third communication link or bus. The tiered energy storage control system, separated from the vehicle controller, gives the system a plug-n-play appearance to the vehicle, and the modular design allows additional energy storage modules to be added on or energy storage modules to be removed easily without requiring any modification to the vehicle control system.

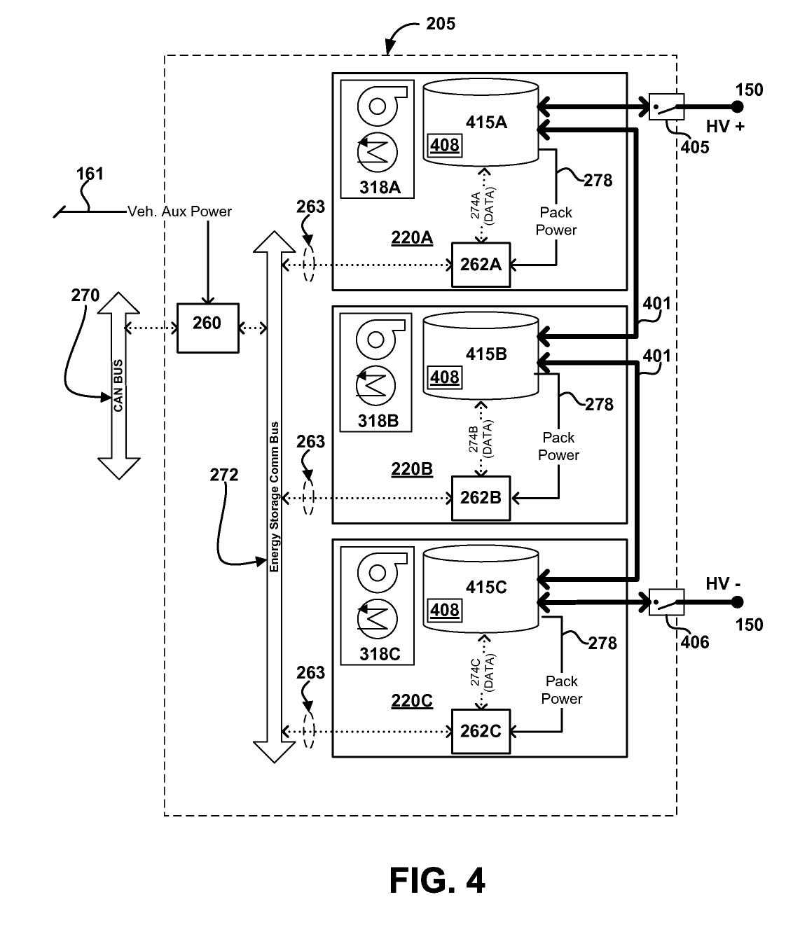

FIGS. 2 and 4 illustrate exemplary embodiments of a propulsion energy storage system 205, which provides energy management and propulsion energy storage for use in a hybrid electric vehicle, which may have a series drive configuration as in FIG. 1 or a parallel drive configuration (not illustrated). In both examples, propulsion energy storage system 205 is illustrated as having three energy storage modules 220A, 220B and 220C connected in series. However, system 205 may include a greater or lesser number of energy storage modules in other embodiments, including an embodiment with only one energy storage module 220A. The actual number of modules may vary, for example, depending on the power requirements of the vehicle in which the system is installed. Thus, individual energy storage modules 220A, 220B . . . 220n (where “n” is the total number of energy storage modules and may be any number greater than zero) are modular, plug-in components and are connected such that modules can be easily added or removed based on a particular vehicle's power requirements, as explained in more detail below.

With regard to controls, in the past, energy storage units themselves have been non-intelligent, and typically only included the energy storage device (e.g., batteries or ultracapacitors), and possibly also some sensors, cooling fans, and/or internal balancing circuitry, all packaged in a housing. Prior energy storage units were also highly integrated into the vehicle propulsion system. The energy storage unit was then controlled by a vehicle or drive system controller, essentially using switches that would electrically couple and de-couple the energy storage to and from the DC bus 150 such that energy/power could be transferred to or from the energy storage unit. In contrast, the architecture illustrated in FIGS. 2 and 4 provides greater separation between the energy storage system and the vehicle drive system, making the energy storage system somewhat like a plug-n-play device. In order to accomplish this independence, and an expandable modularity, the energy storage largely includes its own control system, which is advantageously distributed into tiers based on function.

FIG. 2 is a schematic diagram illustrating one embodiment of a modular propulsion energy storage system of a hybrid electric vehicle which includes a built-in energy storage control system. As illustrated, a system controller 260 forms a first control tier and the heart of the energy storage's control architecture. System controller 260 communicates with energy storage modules 220A, 220B and 220C via a controller communication bus or energy storage communication bus 272, and communicates with the vehicle's control and monitoring system via a vehicle communication bus 270. The low voltage power supply, as described above, supplies stable power to the system controller 260 of the energy storage and control system 205 via line 161. In the illustrated embodiment, system controller 260 is a stand alone device, however, controller 260 may also be integrated into one of the individual energy storage modules or packs 262 in alternative embodiments.

The next control tier includes one or more module controllers. In particular, each energy storage module 220A, 220B, 220C, having a plurality of energy storage cells 122, further includes a module controller 262A, 262B, 262C, respectively. The module controllers 262A to 262C communicate with the system controller 260 via energy storage controller communication bus 272, and communicate with their respective energy storage cells 122 (and any associated sensors and control circuits) via a module communication link or third tier data link 274A, 274B, 274C, respectively. Examples of suitable module controllers are the ADuC703x family of highly integrated, precision battery monitors manufactured by Analog Devices of Norwood, Mass. The individual module controllers 262A to 262C are powered directly by the energy storage cells 122, as illustrated by pack power lines 278. Since each module controller is powered by its own respective module, the vehicle's auxiliary power is not needed to power the module controller, and therefore no electrical coupling is necessary. In this way, maintaining electrical isolation between the high voltage and low voltage systems is greatly simplified. Additionally, this provides for expansion without extra electrical hardware on the vehicle.

In addition to stratifying the control architecture, the system may also include different tiers of communication. In particular, the vehicle communicates to the system controller 260 via bus communications, the system controller 260 communicates with the individual module controllers 262A to 262C via bus communications, and the individual module controllers 262A to 262C communicate within the module via bus and/or direct communications. This tiered communication strategy provides for an expandable energy storage pack/system where energy storage modules 220 may be added or removed without changing the system controller. In addition, module controllers 262A to 262C++?

Each different communication tier may communicate differently. In particular, different communication protocols may be used for the various communication links or buses in the system of FIGS. 2 and 4. For example, vehicle communication bus 270 may be a controller area network (CAN) bus that is communicatively coupled to many components of the HEV, such as a vehicle controller or Electric Vehicle Control Unit or EVCU (not shown). A CAN network is relatively complex and provides high level communications between the various connected components. Once the system controller 260 is connected to the vehicle communication bus 270, it can communicate with nearly any device on the vehicle. Accordingly, the first communication tier may communicate according to a first communication protocol.

Since the energy storage system requires a lower level of communications than is needed for the entire vehicle, the communication protocol used for the energy storage or controller communication bus 272 may be simpler than that of the vehicle communication bus or CAN bus 270, Preferably, in one embodiment, the protocol for controller communication bus 272 may form a local interconnect network (LIN). Likewise, since each module is a self contained unit and doesn't need to expand, the communication protocol used for the module communication bus or data link 274A to 274C may be even simpler than that of the controller communication bus 272. Preferably, in one embodiment, a broadcast serial network or serial peripheral interface (SPI) protocol may be used for each module data link 274.

In the system of FIGS. 2 to 4, because each energy storage module has its own built-in module controller and a separate energy storage system controller communicates with the individual module controllers via a dedicated energy storage communication bus, it is easy to plug in one or more additional energy storage modules as needed, or to take out and replace energy storage modules. All monitoring and control functions for the energy storage system may be shared between the system controller 260 and the individual module controllers 262, with the system controller communicating with the vehicle control system to provide energy storage status and to receive control inputs to connect the high voltage output of the energy storage cells to the vehicle propulsion system and to disconnect the high voltage output as needed. Additionally, according to one alternate embodiment (not shown), system controller 260 and a first module controller (e.g., module controller 262A) may be integrated into a first module (e.g., module 220A), while maintaining electrical isolation between the high voltage system and the low voltage system.

The plurality of energy storage cells 122 in each module may be electrically coupled in series, increasing the pack's voltage. Alternately, energy storage cells 122 may be electrically coupled in parallel, increasing the pack's current, or both in series and parallel. Any suitable energy storage cells may be used in modules 220, such as ultracapacitors as described in U.S. Pat. No. 7,085,112 and U.S. patent application Ser. No. 11/460,738, the contents of each of which are incorporated herein by reference. Energy storage cells 122 may alternatively be battery based, or the like. Individual module controllers 262A, 262B, 262C, respectively, communicate with the energy storage cells 122 in the respective module via the module communication link 274A, 274B, 274C, respectively, for data transfer, and also communicate with various sensors proximate the cells via the same link. The sensors may comprise sensors used for monitoring or controlling energy storage cell parameters and are not shown in detail in the drawings. For example, the energy storage modules 220 may include overvoltage protection circuitry and cell balancing circuits as described in copending application Ser. No. 12/237,529 filed on Sep. 25, 2008, the contents of which are incorporated herein by reference, as well as pre-charge relays, on-off relays, balancing resistors and various pack monitoring sensors as described in U.S. patent application Ser. No. 11/460,738 and U.S. Pat. No. 7,085,112 referenced above.

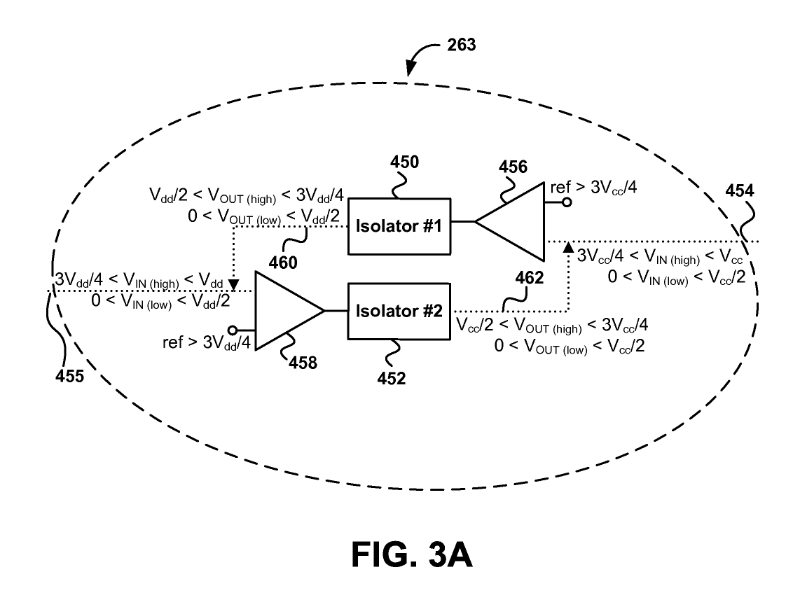

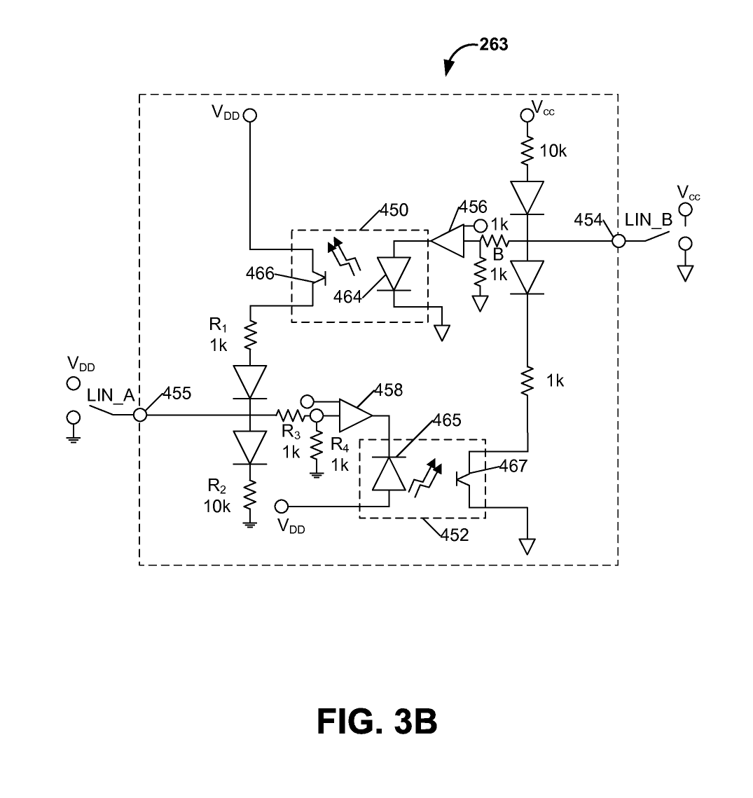

As noted above, the system controller 260 is powered by the vehicle's low voltage auxiliary power system, while the energy storage modules are part of a high voltage system. In view of this, the system controller 260 and controller communication bus 262 are electrically isolated from the energy storage modules via isolator modules or circuits 263, as illustrated in FIGS. 2 and 4. This is advantageous because a failure in the communication link might otherwise lead to a catastrophic electrical coupling of both the high voltage and the low voltage electrical systems. According to one embodiment, the communication over the controller communication bus may be in accordance with single-wire full-duplex communication protocol. An isolator circuit or module 263 may then be connected in the communication line between each module controller 262A, 262B and 262C and the controller communication bus 272. The isolators may be opto-isolators which use short optical transmission paths to transfer signals between opposite ends of the isolator circuit, while keeping the opposite ends electrically isolated since the signal is changed from an electrical signal to an optical signal and then back into an electrical signal. In this way, signals from the energy storage module controllers may be provided to the controller communication bus without exposing it to the vehicle's high voltage system. Isolators 263 are described in more detail below in connection with FIGS. 3A and 3B. While isolators 263 are preferred, it is understood that other wireless communication technologies are contemplated.

FIGS. 3A and 3B illustrate exemplary embodiments of the electrical isolator modules 263 of FIG. 2. As discussed above, the energy storage or controller communication bus 272 is located between a low voltage system (the system controller which is operated by vehicle auxiliary power of the order of 12 volts) and the high voltage system (the energy storage modules 220A,B,C) operating at a much higher voltage. The abovementioned isolators 263 are then used to electrically isolate the low voltage system from the high voltage system, while still transmitting data such as energy storage parameters and control signals between the two controllers so that they can carry out their monitoring and control functions. Preferably, each isolator module 263 comprises two opto-isolators 450, 452 connected in opposite directions between the input/output 454 on the energy storage side of the isolator and the input/output 455 on the controller communication bus/low voltage side of the isolator. In this way, full-duplex communications may be enabled.

In a single-wire full-duplex application, the isolator module may be configured to distinguish original system controller signals and energy storage module signals from each other, so that only original system controller signals are passed across the electrical isolator from left to right to the module controller, as illustrated in FIG. 3A, and only energy storage module signals are passed across the electrical isolator to the system controller from right to left, as illustrated in FIG. 3A. In particular, a comparator 456, 458 at the input of each isolator determines the input voltage which will trigger the opto-isolator. This arrangement is such that a signal output from one of the two opto-isolators, for example at the output 460 of isolator 450, is not high enough to trigger the other isolator 452 to produce output at isolator output 462, which could potentially trigger an erroneous digital output signal at the input/output terminals 454 associated with the input to the first isolator 450. Instead, an incoming signal at input 454 is only output at the terminals 455 at the opposite end of the circuit as a digital signal.

In the example illustrated in FIG. 3A, each isolator is triggered only if the input voltage is greater than ¾ Vcc or ¾ Vdd, respectively, while the isolator high voltage output of isolator 450 is less than ¾ Vdd and the high voltage output of isolator 452 is less than ¾ Vcc. Thus, the high voltage output signal at the Vdd terminals 455 is between ½ Vdd and ¾ Vdd, and the high voltage output signal at the Vcc terminals 454 is between ½ Vcc and ¾ Vcc, as indicated in the drawing. The input signal at the Vcc terminals which triggers the isolator 450 is greater than ¾ Vcc, while the input signal at the Vdd terminals which triggers isolator 452 is greater than ¾ Vdd.

FIG. 3B illustrates one detailed embodiment of an isolator circuit 263. It will be understood that there are many possible circuit configurations to carry out the functions illustrated in FIG. 3A, and the circuit of FIG. 3B is just one example of a suitable circuit. In FIG. 3B, the optical isolators 450 and 452 each comprise a light emitting diode (LED) 464, 465, respectively, and a phototransistor 466, 467, respectively which is triggered by an output from the associated LED. The desired isolator triggering voltages, which may be ¾ Vcc and ¾ Vdd as indicated in FIG. 3A, or other selected triggering voltages in other embodiments, are determined by means of voltage dividers across the comparator inputs, as illustrated in FIG. 3B.

FIG. 4 shows a block diagram of the system of FIG. 2 highlighting additional details. As above, each energy storage unit or module 220A to 220C has its own dedicated, “intelligent” module controller 262A to 262C, respectively, that is coupled to a series of individual energy storage cells 122. Each module controller 262A to 262C includes a processor (not shown), and is communicatively coupled to the energy storage system controller 260 via energy storage communication bus 272.

As discussed above, the architecture of energy storage system 205 is much more readily adjustable to add or remove energy storage packs (e.g., 220A to 220n+1) than prior art systems, which generally require, at a minimum, modification of the vehicle controller in order to allow such modifications to be made. As indicated in FIG. 4, the series of all energy storage cells 122 in each successive module are interconnected in series via lines 401, with opposite ends of the entire series connected to a positive and a negative contactor (or similar switching device) 405 and 406. The switching devices 405 and 406 of the energy storage system 205 may then be used to control connection to the vehicle's DC high power bus 150.

According to one embodiment, the system controller 260 may control the electrical coupling of the energy storage modules to and from the high voltage DC bus 150 via energy storage system contactors (or switches) 405 and 406. In addition to their control function, these dual switches 405, 406 also aid in increasing electrical isolation protection. In addition, although not illustrated, each module 220 may further include a module fire system configured to report and/or extinguish energy storage fires or fire conditions, a safety electrical disconnect of the module configured to manually safe the energy storage, and individual module contactors configured to electrically couple and de-couple the module.

According to one embodiment, each energy storage module 220A, 220B, and 220C may also include a dedicated cooling module 318A, 318B, and 318C, respectively. As illustrated, each cooling module may include a heat exchanger and a cooling device, such as a fan or blower. Cooling modules 318A, 318B, and 318C may operate as part of a open loop system or a closed loop system. Moreover, cooling modules 318A, 318B, and 318C may be coupled with a vehicle heat exchanger or vehicle cooling system (not shown) to simplify the heat exchanger of the cooling module. For example, dedicated cooling modules 318A, 318B, and 318C may include the energy storage pack cooling system as described more fully in copending application Ser. No. 12/343,970 filed on Dec. 24, 2008, the contents of which are incorporated herein by reference.

According to one embodiment, sensors such as temperature sensors may be located proximate the cells and/or throughout the module. The cooling device may be switched on automatically if the detected temperature in the module is above a predetermined level, and switched off when the temperature falls below a threshold level. The cooling modules 318A to 318C may be controlled by their respective module controllers or by the system controller. As such, the cooling device may be switched on upon receiving a command from either, responsive to a measured temperature or other criteria.

As illustrated here, the series of energy storage cells 122 in each energy storage module 220A to 220C, as well as any associated sensors and control circuits, are represented collectively by cell modules 415A, 415B and 415C. Each cell module is shown having a cell balancing module 408 configured to monitor and balance the energy storage cells within the module. The cell balancing circuit or module 408 may be embodied by hardware, software, or a combination of both, and may alternately be incorporated in the module controllers 262A-C or may be a separate component in each energy storage module. Additionally, the series of energy storage cells 122 may be arranged in strings (not shown), whereas the cell balancing module 408 may be embodied as one or more circuits integrated with the strings of energy storage cells 122.

In one embodiment, cell balancing circuitry or cell balancing and protection circuitry 408 is provided in each energy storage module 220A-C to monitor and protect the energy storage cells 122 in the respective energy storage module and to balance charges between the storage cells according to a desired operational configuration corresponding to a set of predetermined measurement parameters. Cell balancing is very important to the health of the energy storage and may dramatically affect its useful life. Each cell balancing circuit is electrically coupled to each energy storage cell of a string. Where plural strings are involved, each module may have a single cell balancing circuit coupled to each cell in each of the strings, or a separate cell balancing circuit may be coupled with each string. Each cell balancing circuit is configured to measure the voltage level of each cell and to actively balance the voltages between the energy storage cells based on an operating configuration determined from a current set of measurement parameters, as described in more detail below. The module controllers 262A to 262C control the cell balancing circuit to balance the energy storage cells according to the latest operating configuration. As above, each cell balancing circuit may be incorporated into the respective module controller 262A, 262B, or 262C, or may be independent but communicatively coupled with the respective module controller via the associated data communication link 274A, 274B, or 274C. In addition, cell balancing and protection circuitry 408 may determine voltage, temperature and other cell information, which may be then used to determine SOC and protect against faults and failures.

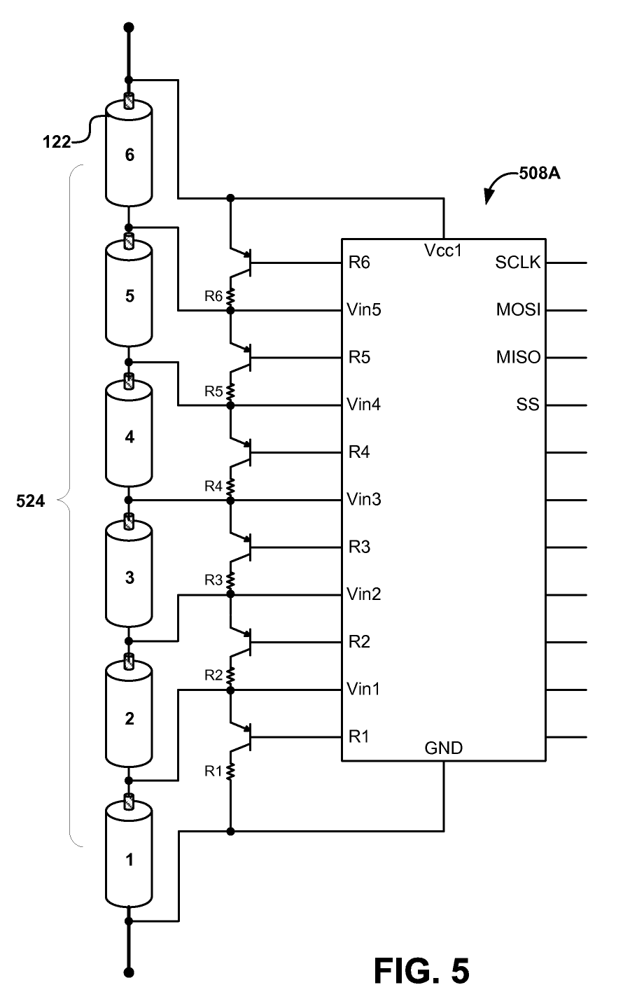

FIG. 5, illustrates one generic embodiment of a cell balancing circuit. In particular, the cell balancing circuit is embodied as a string level integrated circuit (IC) 508A interfacing with each cell of a string of cells 524, wherein balancing circuitry may reside in or out of the IC. Although string 524 is shown having six energy storage cells 122, it is understood any convenient and appropriate number of cells 122 may form string 524 and be used in a cell module (e.g., cell module 415A). It is further understood that additional functionality may be incorporated into IC, such as cell/string/module communications. For example, IC 508A is illustrated as including an SPI communication interface. Accordingly, IC 508A may also form part of a module communication link (e.g., module communication link 274A). Moreover, the functionality described herein may be distributed within a module (e.g., module 220A) between its controller (e.g., module controller 262A), its communication link (e.g., module communication link 274A), and one or more ICs (e.g., IC 508A). For example, active cell balancing may be performed in the IC 508A based on commands or parameters communicated from the module controller 262.

As discussed above, the system controller 260 is configured or programmed to communicate with the vehicle and to communicate with one or more module controllers 262A-C. In one embodiment, the system controller 260 may be configured to determine the state of charge (SOC) and state of health (SOH) of the energy storage modules based on sensor outputs received from the module controllers 262A-C. In another embodiment, the system controller 260 may also be configured to also to carry out comprehensive diagnostics. The diagnostics may include pre-operation diagnostics, e.g. self-check of individual energy storage pack components, operation diagnostics, and historical/statistical diagnostics. The operation diagnostics may include real-time operation diagnostics such as checking for conditions such as overvoltage, pack electrical isolation, pack seal breach, and state of charge of individual cells in each pack or energy storage module. The diagnostics may be carried out based on inputs received from the individual storage module controllers 262A to 262C, cell balancing and protection circuitry 408, ICs 508A, and/or inputs from other vehicle components or subsystems. The system controller 260 may also be configured to control the pack or energy module contactors or switches 405, 406, the module cooling systems 318A, 318B, 318C, and the energy module pre-charge circuits (not illustrated).

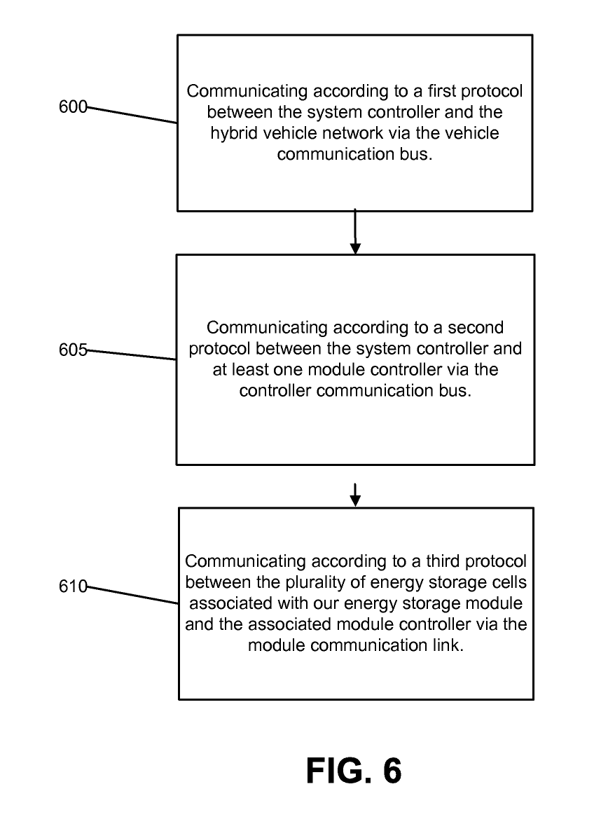

FIG. 6 illustrates a communication method for controlling a propulsion energy storage of a hybrid electric vehicle such as the systems of FIGS. 2 and 4. This method comprises communicating according to a first protocol between a system controller and a hybrid vehicle network via vehicle communication bus 270 (step 600), communicating according to a second protocol between the system controller and the individual module controllers via controller or energy storage communication bus 272 (step 602), and communicating within each energy storage module between its module controller and the plurality of energy storage cells, via the module communication link 274A, 274B or 274C according to a third protocol (step 610). In addition, the method would include powering the system controller with the vehicle's low voltage power supply, but self-powering the module controller(s) with their energy storage cells. According to one preferred embodiment, the first communication protocol is a message-based bus protocol (e.g., controller area network (CAN) protocol), the second communication protocol is a single-wire full-duplex bus protocol (e.g., local interconnect network (LIN) protocol), and the third communication protocol is a simpler full-duplex serial communication protocol (serial peripheral interface (SPI) protocol).

According to one embodiment, the method would include electrically isolating communications between the module controller(s) and the controller communication bus, wherein the electrical isolation further comprises distinguishing original system controller signals and isolated energy storage signals from each other, such that only original system controller signals are passed across an electrical isolator to the respective module controller and only isolated energy storage signals are transmitted out of the electrical isolator to the controller communication bus.

According to one embodiment, the communication method may further include providing certain communications between the hybrid electric vehicle and the system controller 260. In particular, the system controller 260 will preferably include communicating the state of charge (SOC) and state of health (SOH) of the propulsion energy storage system 205. This information may be used by the drive system to optimize its efficiency and performance. Likewise, this information may be logged or reported to maintenance personnel. According to one embodiment, the method may further include the system controller 260 and hybrid electric vehicle communicating a comprehensive diagnosis of at least part of the propulsion energy storage system 205, where the comprehensive diagnosis includes at least one of pre-operation diagnostics, operation diagnostics and historical/statistical diagnostics, as discussed in greater detail below.

This control system and method provides tiered high, mid, and low level communications and separates vehicle-level communications/control functions from the energy storage system communications/control functions, making the system more modular and more readily expandable. This is different from existing energy storage systems and control of such systems, which are typically integrated with the vehicle control system so that the energy storage system cannot be modified without also requiring modification of the vehicle control system to adapt to the expanded energy storage system.

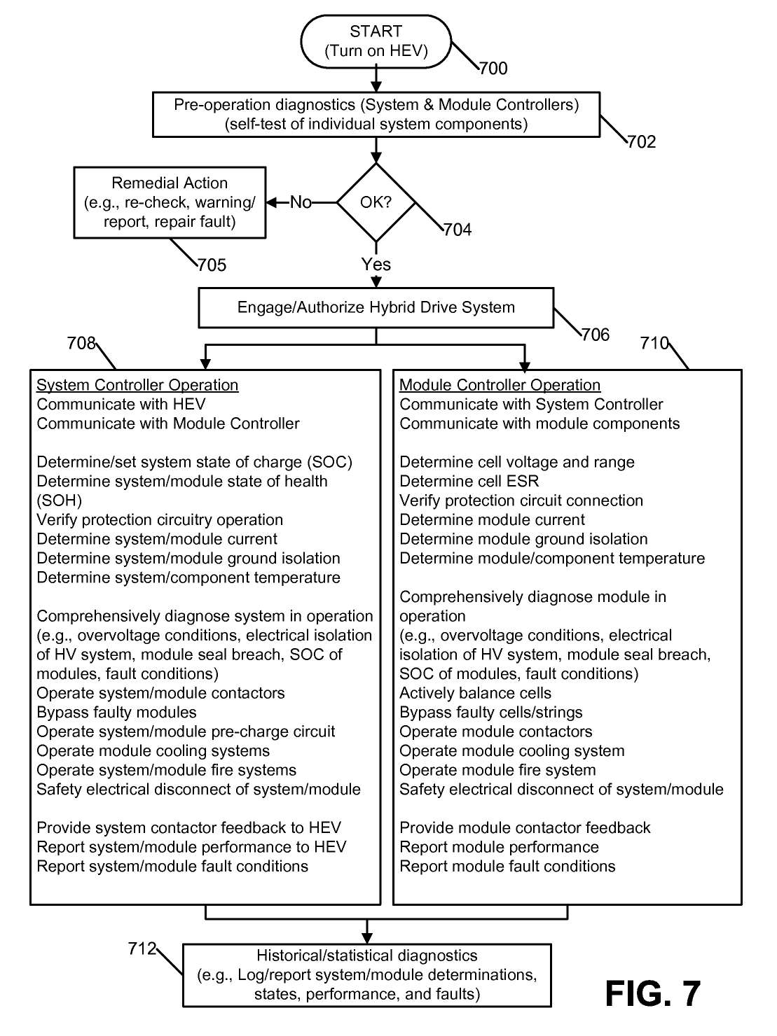

FIG. 7 is a block diagram illustrating one embodiment of a method for controlling and monitoring the system of FIGS. 2 to 4. As mentioned above and also illustrated in FIG. 7, when the hybrid electric vehicle is turned on (step 700), the system controller and the one or more module controllers may each perform a set of pre-operation diagnostics (step 702), comprising a self-test of individual system components. If any of the pre-operation diagnostics self-tests fail (step 704), suitable remedial action is taken (step 705), such as a system re-check, a warning light, an error report, or a fault repair. If the diagnostic self-test checks “ok” at step 704, the hybrid drive system is authorized and engaged at step 706. Subsequently, the system controller and module controllers may perform a series of pre-programmed operation functions as listed in the boxes 708 and 710 of FIG. 7. Some identical functions are listed in both the system controller box 708 and the module controller box 710. This means that these functions may optionally be performed either by the system controller 260 or the module controller 262A,B,C, or redundantly be performed by both.

As indicated in box 708 of FIG. 7, the system controller 260 communicates with both the HEV (via vehicle communication bus 270) and with the module controllers 262 (via controller communication bus 272). System controller 260 also determines/sets the system state of charge (SOC) and in one embodiment it may also determine the system state of health (SOH), the system and module current, the system and module ground isolation, and system and module temperature, and take appropriate remedial action if any of these are outside predetermined operating parameters. The system controller 260 may continue to carry out comprehensive system diagnostics during operation of the system, which may include: monitoring for overvoltage conditions, electrical isolation of the high voltage system, module seal breach, SOC of modules, and fault conditions in any components, and may further take appropriate remedial action (e.g., bypass of faulty modules) if any problems are detected.

The system controller 260 may also be configured to operate the system/module contactors, pre-charge circuit of the propulsion energy storage, module cooling systems, system/module fire systems, and safety electrical disconnect of the system or individual modules. The system controller 260 may also provide system contactor feedback to the HEV and provide reports of system/module performance and system/module fault conditions to the HEV.

As indicated in box 710 of FIG. 7, module controller operation may include: communication with the system controller over the controller communication bus 272 and communication with the energy storage module components over the module communication link 274. The module controller 262 may also determine the cell equivalent series resistance (ESR) and the cell voltage and range. Unless these functions are carried out by the system controller 260, each module controller also determines the module current, the module ground isolation, and the module and component temperatures.

As indicated in box 710, during operation, each module controller 262 may continue to comprehensively diagnose module operation, monitoring for overvoltage conditions, isolation of the high voltage system, module seal breach, SOC of the module, and fault conditions. The module controller 262 also operates to actively balance the cells in its module, as described above in connection with FIGS. 4, 5A, 5B, and also to bypass any detected faulty cells or cell strings. The module controller may also operate the module contactors, module cooling system, module fire system, and safety electrical disconnect of the module, unless these functions are carried out by the system controller. Each module controller 262A . . . 262n also provides module contactor feedback and reports module performance and fault conditions to the system controller.

Both levels of controller may also be configured to carry out historical/statistical diagnostics over time (Step 712). This may comprise logging or reporting system and module operating parameter determinations, states, performance characteristics, and faults.

Those of skill will appreciate that the various illustrative logical blocks, modules, and algorithm steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the design constraints imposed on the overall system. Skilled persons can implement the described functionality in varying ways for each particular application, but such implementation decisions should not be interpreted as causing a departure from the scope of the invention. In addition, the grouping of functions within a module, block or step is for ease of description. Specific functions or steps can be moved from one module or block without departing from the invention.

Various illustrative logical blocks and modules described in connection with the embodiments disclosed herein can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A control system specially adapted for a propulsion energy storage of a hybrid electric vehicle, the hybrid electric vehicle including a vehicle communication bus, a low voltage power supply, and a propulsion power supply, the propulsion energy storage including one or more energy storage modules each having a plurality of energy storage cells, the control system comprising:
a system controller configured to communicate with the hybrid vehicle via the vehicle communication bus, the system controller powered by the low voltage power supply;
a controller communication bus communicatively coupled with the system controller;
a first module controller associated with a first energy storage module of the one or more energy storage modules, the first module controller configured to communicate with the system controller via the controller communication bus; and
a first energy storage cell communication link communicatively coupled with the first module controller;
the first module controller further configured to communicate with a first plurality of energy storage cells associated with the first energy storage module via the first energy storage cell communication link, the first module controller powered by the first energy storage module.

2. The control system of claim 1, further comprising a second module controller associated with a second energy storage module and a second energy storage cell communication link communicatively coupled with the second module controller, the second module controller configured to communicate with the system controller via the controller communication bus, the second module controller further configured to communicate with a second plurality of energy storage cells associated with the second energy storage module via the second energy storage cell communication link, the second module controller powered by the second energy storage module.

3. The control system of claim 1, further comprising an electrical isolator configured to electrically isolate communications between the first module controller and the controller communication bus.

4. The control system of claim 3, wherein communications over the controller communication bus are in accordance with a single-wire full-duplex communication protocol, and the electrical isolator is further configured to distinguish original system controller signals and isolated energy storage signals from each other, such that only original system controller signals are passed across the electrical isolator to the first module controller and only isolated energy storage signals are transmitted out of the electrical isolator to the controller communication bus.

5. The control system of claim 4, wherein the electrical isolator includes two voltage dividers and two comparators.

6. The control system of claim 1, wherein the system controller is further configured to determine at least one of a state of charge (SOC) and a state of health (SOH) of the propulsion energy storage.

7. The control system of claim 6, wherein the system controller is configured to perform comprehensive diagnostics on at least part of the propulsion energy storage, wherein the comprehensive diagnosis includes at least one of pre-operation diagnostics, operation diagnostics and historical/statistical diagnostics.

8. The control system of claim 1, wherein the system controller is further configured provide propulsion energy storage contactor feedback to the hybrid electric vehicle.

9. The control system of claim 1, wherein the system controller is further configured to determine at least one of current through the one or more energy storage modules and ground isolation of the one or more energy storage modules.

10. The control system of claim 1, wherein the first module controller is further configured to perform at least one of: determine temperature proximate one or more of the energy storage cells associated with the first energy storage module, control contactors of the first energy storage module, provide module contactor feedback to the hybrid electric vehicle, and control a cooling system of the first energy storage module.

11. The control system of 1, wherein the system controller communicates over the vehicle communication bus using a first communication protocol and over the controller communication bus using a second communication protocol.

12. The control system of 11, wherein the first communication protocol is a controller area network (CAN) protocol and the second communication protocol is a local interconnect network (LIN) protocol.

13. The control system of claim 12, wherein the first module controller is configured to communicate over the first energy storage cell communication link using a third communication protocol.

14. The control system of 13, wherein the third protocol is a serial peripheral interface (SPI) protocol.

15. A propulsion energy storage system specially adapted for a hybrid electric vehicle, the hybrid electric vehicle including a vehicle communication bus and a low voltage power supply, the energy storage system comprising:
a system controller configured to communicate with the vehicle communication bus, the system controller having a low voltage power input configured for connection to the low voltage power supply of the vehicle;
a controller communication bus communicatively coupled with the system controller; and
a first energy storage module having a first plurality of energy storage cells, a first module controller, and a first energy storage cell communication link communicatively coupled with the first module controller and the first plurality of energy storage cells;
the first module controller being powered by the first plurality of energy storage cells and configured to communicate with the system controller via the controller communication bus.

16. The system of claim 15, further comprising a plurality of energy storage modules each having a respective module controller configured to communicate with the system controller via the controller communication bus, each energy storage module having a plurality of energy storage cells and a respective energy storage cell communication link communicatively coupled with the respective plurality of energy storage cells and the respective module controller.

17. The system of claim 15, further comprising an electrical isolator configured to electrically isolate communications between the first module controller and the controller communication bus.

18. The system of claim 15, wherein the first energy storage module further comprises contactors configured to control connection of a DC voltage output of the energy storage cells to a DC high voltage bus of the vehicle.

19. The system of claim 18, further comprising a plurality of additional energy storage modules connected in series between the first energy storage module and the contactors.

20. The system of claim 19, wherein each energy storage module further comprises a respective pre-charge circuit, and at least one cooling system is associated with the energy storage modules, the system controller being further configured to control at least the pre-charge circuit of each energy storage module, the contactors of the energy storage modules, and the cooling system associated with the energy storage modules.

21. The system of claim 15, wherein the first energy storage module includes a cooling system and the first module controller is configured to control the cooling system.

22. The system of claim 15, wherein the first module controller is configured to balance one or more of the first plurality of energy storage cells associated with the first energy storage module during at least one of charging and discharging.

23. The system of 15, wherein the system controller communicates over the vehicle communication bus using a first communication protocol and over the controller communication bus using a second communication protocol different from the first communication protocol.

24. The system of claim 23, wherein the first module controller is configured to communicate over the controller communication bus using the second communication protocol and is configured to communicate with the first plurality of energy storage cells over the storage cell communication link using a third communication protocol different from the first and second communication protocols.

25. The system of claim 24, wherein the first communication protocol is a higher level communication protocol than the second communication protocol, and the second communication protocol is a higher level communication protocol than the third communication protocol.

26. The system of claim 15, wherein the first plurality of energy storage cells are electrically coupled in series and grouped into a plurality of strings, with each string comprising a subset of the first plurality of energy storage cells, the first energy storage cell communication link includes cell protection and balancing circuitry associated with each string, the cell protection and balancing circuitry associated with each string electrically coupled to each energy storage cell of the string, and the cell protection and balancing circuitry is configured to measure voltage levels of each cell of the string and to actively balance voltages between the energy storage cells of the string.

27. The system of claim 26, wherein the cell protection and balancing circuitry associated with each string is communicably coupled in series forming a daisy chain, and the daisy chain is communicably coupled to the first module controller.

28. A method for controlling propulsion energy storage of a hybrid electric vehicle, the hybrid electric vehicle including a vehicle communication bus, a low voltage power supply, and a propulsion power supply, the propulsion energy storage including a system controller, a controller communication bus, and one or more energy storage modules, each energy storage module having a module controller and a plurality of energy storage cells, the method comprising:
powering the system controller with the low voltage power supply;
powering a first module controller of a respective first energy storage module with a first plurality of energy storage cells associated with the first energy storage module;
communicating between the hybrid electric vehicle and the system controller via the vehicle communication bus according to a first communication protocol;
communicating between the system controller and the first energy storage module via the controller communication bus according to a second communication protocol; and
communicating between the first module controller and the first plurality of energy storage cells via a first energy storage cell communication link according to a third communication protocol.

29. The method of claim 28, further comprising electrically isolating communications between the first module controller and the controller communication bus.

30. The method of claim 28, wherein the propulsion energy storage includes a plurality of energy storage modules each having a dedicated module controller, a plurality of energy storage cells, and a respective energy storage cell communication link, the method further comprising communicating between the system controller and each energy storage module via the controller communication bus according to the second communication module, and communicating between each energy storage module controller and the plurality of energy storage cells in the respective energy storage module via the respective energy storage cell communication link according to the third communication protocol.

31. The method of claim 30, further comprising electrically isolating communications between each module controller and the controller communication bus.

32. The method of claim 31, wherein the second communication protocol comprises a single-wire full-duplex communication protocol.

33. The method of claim 32, wherein the electrical isolation further comprises distinguishing original system controller signals and isolated energy storage signals from each other, such that only original system controller signals are passed across an electrical isolator to the respective module controller and only isolated energy storage signals are transmitted out of the electrical isolator to the controller communication bus.

34. The method of claim 28, wherein communication between the hybrid electric vehicle and the system controller comprises communicating at least one of a state of charge (SOC) and a state of health (SOH) of the energy storage.

35. The method of claim 34, wherein communication between the hybrid electric vehicle and the system controller further comprises communicating a comprehensive diagnosis of at least part of the propulsion energy storage, and the comprehensive diagnosis includes at least one of pre-operation diagnostics, operation diagnostics and historical/statistical diagnostics.

36. The method of claim 35, further comprising the system controller controlling at least one of a pre-charge circuit of the propulsion energy storage, contactors of the propulsion energy storage, and one or more cooling systems associated with the one or more energy storage modules.

37. The method of claim 28, further comprising the system controller providing propulsion energy storage contactor feedback to the hybrid electric vehicle.

38. The method of claim 28, further comprising the system controller determining at least one of current through the one or more energy storage modules and ground isolation of the one or more energy storage modules.

39. The method of claim 28, further comprising the first module controller performing at least one of: determining temperature proximate one or more of the first plurality of energy storage cells, providing module contactor feedback to the hybrid electric vehicle, and controlling a cooling system of the first energy storage module.

40. The method of claim 28, further comprising the first module controller balancing the one or more of the first plurality of energy storage cells during at least one of charging and discharging.

41. The method of claim 28, wherein the first communication protocol is a controller area network (CAN) protocol and the second communication protocol is a local interconnect network (LIN) protocol.

42. The method of claim 28, wherein the third communication protocol is a serial peripheral interface (SPI) protocol.

43. The method of claim 28, further comprising measuring voltage levels of each energy storage cell of the first plurality of energy storage cells, the first plurality of energy storage cells being arranged in a plurality of strings of energy storage cells coupled in series using cell protection and balancing circuitry associated with each string, and the first module controller controlling the cell protection and balancing circuitry to actively balance voltages between the energy storage cells of the string based on measured voltage levels.
